(19) United States
(12) Patent Application Publication
(10) Pub. No.: US 2011/0048825 A1
(43) Pub. Date: Mar. 3, 2011

(54) AIR CONDITIONER FOR ELECTRIC CAR

(76) Inventor: Gary Starr, Santa Rosa, CA (US)

(21) Appl. No.: 12/550,325

(22) Filed: Aug. 28, 2009

(51) Int. Cl. B60K 1/00; B60H 1/32; F25D 17/06; F25B 27/00; F25B 1/00

(52) U.S. Cl. 180/65.51; 62/244; 62/419; 62/235.1; 62/428; 62/498

(57) ABSTRACT

An electric vehicle includes a frame having a cab; a plurality of hub wheel motors mounted to the frame, each hub wheel motor rotating a wheel; and an air conditioner mounted on the frame and thermally coupled to the cab, wherein the air conditioner includes an inverter driving an electric compressor and the inverter is coupled to an independent battery for air conditioning.

The present invention relates to an automotive air conditioner for electric vehicles.

### BACKGROUND

In general, an automotive air conditioner comprises a compressor driven by an automotive engine, a condenser for condensing refrigerant compressed by the compressor, a receiver for separating the condensed refrigerant into gas and liquid phases and storing the liquid refrigerant, an expansion valve for throttling and expanding high-temperature, high-pressure refrigerant into atomized low-temperature, low-pressure refrigerant, and an evaporator for evaporating the atomized refrigerant by heat exchange between the atomized refrigerant and air in the vehicle compartment and then returning the evaporated refrigerant to the compressor. As the expansion valve, a thermostatic expansion valve controls the flow rate of refrigerant delivered into the evaporator by sensing the temperature and pressure of refrigerant at the refrigerant outlet of the evaporator.

As discussed in United States Patent Application 20080141691, in a conventional internal combustion engine (ICE) car, the compressor, the condenser, and the receiver are arranged in an engine room along with the automotive engine, while the evaporator is disposed in the vehicle compartment. Further, the expansion valve is disposed between the evaporator and the compressor and between the evaporator and the receiver. The expansion valve is typically disposed in a firewall separating the engine room from the vehicle compartment such that the body block of the expansion valve is also used as a pipe joint for connecting between the evaporator in the vehicle compartment and the compressor and the receiver in the engine room.

In a parallel trend, the rising cost of oil and global warming indications have sensitized manufacturers and consumers to the need to be energy efficient and environmentally responsible. As a result, modern electric cars are becoming popular again. One type of electric car provides a hub wheel motor in each wheel. The advantage of this design is that no additional transmission system is needed, thereby increasing the efficiency of the drive system. However, it is difficult to tap into the electric hub wheel motors to drive an air conditioner to cool the vehicle cab.

### SUMMARY

In one aspect, an electric vehicle includes a frame having a cab; a plurality of hub wheel motors mounted to the frame, each hub wheel motor rotating a wheel; and an air conditioner mounted on the frame and thermally coupled to the cab, wherein the air conditioner includes an inverter driving an electric compressor and the inverter is coupled to an independent battery for air conditioning.

In another aspect, a method for operating an electric vehicle includes providing a plurality of hub wheel motors to a frame with a cab, each hub wheel motor rotating a wheel; providing an independent battery to power an electric compressor and converting the independent battery's voltage to a compressor voltage with an inverter; driving an electric compressor with the compressor voltage; generating and directing cool air at a vehicle interior with a fan or a blower.

Implementations of the above aspects may include one or more of the following. The system can provide cooled air to a driver vent or a passenger vent. The system can sense a battery voltage or a battery temperature and turning off the electric compressor and the fan if the battery voltage falls below a battery voltage threshold or if the battery temperature rises above a battery temperature threshold. The controller can adjust the air conditioner based on a cabin temperature sensor. The air conditioner can be powered by a solar cell. The conditioner battery can also be recharged with an on-board recharger.

Advantages of the system may include one or more of the following. The air conditioning system contributes to the excellence of life and creates a comfortable and vigorous vehicular environment, apart from outside conditions. The air conditioning system keeps the temperature to a comfortable range because of its cooling capability. The system offers the capability of controlling humidity in the temperature while cooling down the air. The system also provides freshening and ventilation. The system can have an efficient purification system that purifies the air as well. Filters can be integrated within the fan assembly or air ducts to purify the air. Dust filters can be used to collect very small particles of dust and microorganisms to avoid the spread of bacteria. The AC, when equipped with filters can assist patients suffering from asthma or allergies.

### BRIEF DESCRIPTION OF THE DRAWINGS

FIG. 1 shows an exemplary air conditioning system.

FIGS. 2A-2B show an exemplary embodiment of the air conditioner.

FIG. 3 shows an exemplary hardware mounting configuration for the air conditioner of FIGS. 2A-2B.

FIG. 4 shows an exemplary electric heater/fan used in an electric vehicle with hub wheel motors.

FIG. 5 shows an exemplary environmentally friendly vehicle control system.

### DESCRIPTION

The following description of various disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

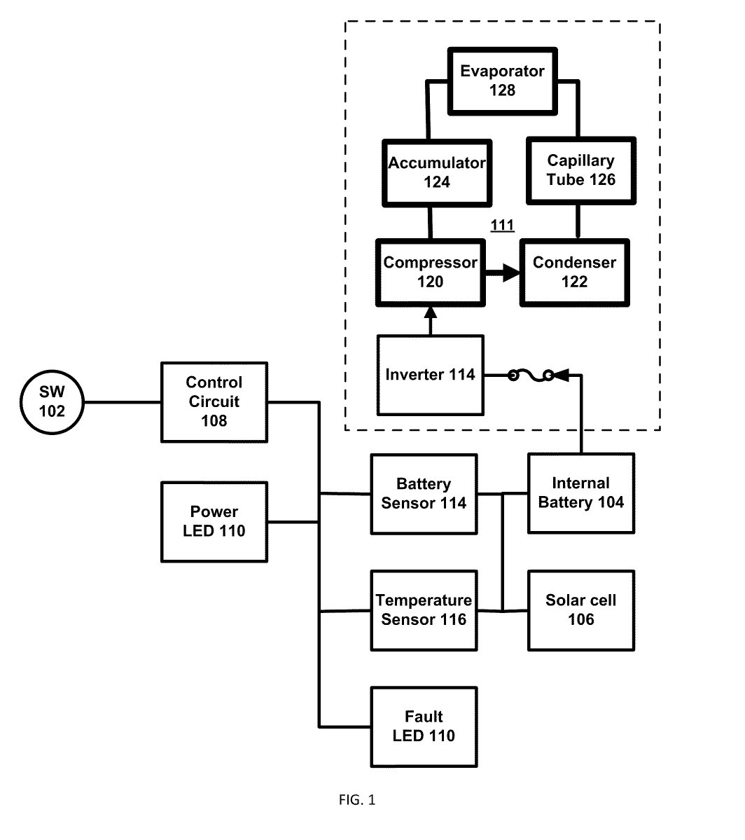

FIG. 1 shows an exemplary air conditioner for electric vehicles. In the embodiment of FIG. 1, the electric vehicle is powered by a plurality of hub wheel motors which are motors directly positioned in the wheels and thus can directly drive the electric vehicle with little or no transmission gears. The electric vehicle of FIG. 1 has an air conditioner that does not use the output of the hub wheel motors. Rather, the air conditioner (AC) 111 of FIG. 1 provides energy to an electric inverter 114 which drives an electric compressor 120.

The power is supplied to a control circuit 108 from the car battery, not shown, when a switch 102 is placed in the on position. The switch 102 can be a 3 way switch to turn on only air conditioning, only fan, or both AC and fan. Alternatively, the switch 102 can provide the user with a fine grain control of the fan speed to precisely adjust the cabin temperature. Power is also supplied by a secondary battery 104 within the housing when the switch connects the battery 104 to the AC control circuit 108. The control circuit 108 can turn on the AC 111. Additionally, a solar panel 106 can directly power the air conditioner or the solar panel can recharge the internal battery 104. When power is supplied to the AC control circuit 108 the power indicator light 110 and AC 111 are turned on. A blower 140 is adapted to generate a flow of air through vents in a passenger compartment of the vehicle only during the receipt of a voltage.

A battery sensor 114 and a temperature sensor 116 constantly monitor the battery power of the internal battery 104 and/or car battery and the temperature of the outside air, respectively. When either the battery power gets too low or the temperature gets too high the sensors 114 or 116 causes an indicator light 118 to be turned on to inform the user of a problem.

The AC 111 uses the inverter 114 to convert the DC voltage of the battery 104 to an alternating current to power a main powered air conditioner. To protect the car and AC 111, the AC 111 has its own fuse going to the inverter 114. Thus, when the AC 111 draws too much power through the inverter 114, a fuse will trip to shut down the AC 111 without shutting down the rest of the vehicle. The fuse can be a time delayed fuse in one embodiment. The inverter powers an electric compressor 120.

The compressor 120 is an electric compressor is responsible for compressing a refrigerant gas, often freon or R134a. The electric compressor 120 takes the refrigerant (the gas) and pressurizes it so it will cool the air. Conventionally the compressor is driven by an internal combustion engine through an engine belt. The compressor 120 can be electrically turned on and off as the cab occupants request cool air. Once the gas is compressed, it becomes heated and is sent through a set of coils to a condenser 122. The condenser 122 is where the heat is separated from the gas. Hot air comes off the top of the condenser 122, while the rest of the gas is condensed into a cool liquid. The output of the condenser 122 is connected to a capillary tube 126 which in turn is connected to an evaporator 128. The evaporator 128 is connected to an accumulator 124. The AC 111 can have either have an orifice tube or capillary tube 126 that regulates the flow of liquid to an evaporator 128 and this is what the user controls when the user changes the temperature settings on the vehicle's dashboard.

In one embodiment, the processor keeps track of time by using a dedicated clock/timer chip or alternatively by internally counting clock pulses and translating the clock pulses to seconds, minutes, and hours. The user can provide instruction to the processor to turn on the AC at a predetermined time. The user can also specify the cabin temperature to be maintained. Thus, if the user plans to drive at 4 pm after work, then the user can program the AC to be turned on at 3:50 pm to cool the cab temperature so that the vehicle is ready for use at 4 pm.

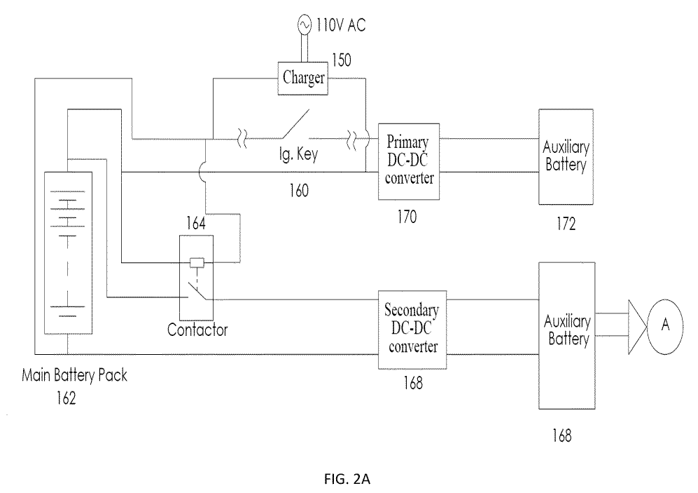

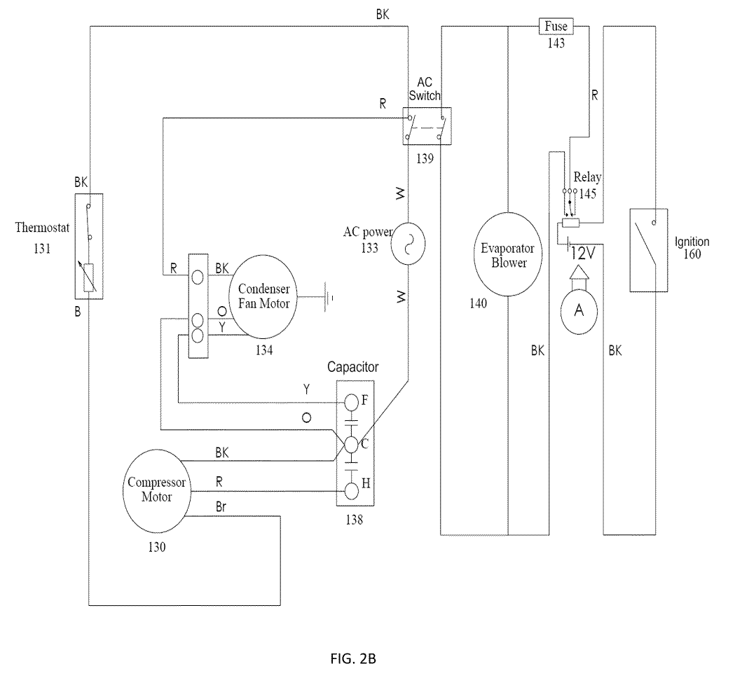

FIGS. 2A-2B show an exemplary embodiment of the air conditioner 111. FIG. 2A shows the power conversion portion of the AC 111, while FIG. 2B shows a portion of the AC 111 which is powered by the power conversion portion of FIG. 2A.

Turning now to FIG. 2A, a charger 150 is provided on board the electric vehicle to recharge the battery of the vehicle. In one embodiment, the AC 111 can be operated while the key 160 is on (driving) or when the vehicle is plugged into a power line such as 110 VAC. The output of the charger 150 is provided to the main battery pack 162 which is connected to a high voltage contactor 164 such as a 72V contactor. The contactor 164 provides power to a secondary DC-DC converter 166 which charges an AC auxiliary battery 168. Power from the battery 168 is provided to circuits of FIG. 2B through a connector A. In parallel, the charger 150 is also connected to a primary DC-DC converter 170 which charges an auxiliary battery 172.

Referring now to FIG. 2B, power from connector A is provided to a relay 145, which is turned on and controlled by the ignition key 160. The power gated by the relay 145 travels through a fuse 143. Power is then controlled by a switch 139 before it is provided to an evaporator blower 140.

Power is also supplied to thermostat 131 which is connected to a compressor motor 130. The compressor motor 130 is also connected to a capacitor 138. The capacitor 138 receives power through a fuse 133 and is connected to a condenser fan motor 134. The capacitor 138 is used to provide clean power to the electric compressor motor 130.

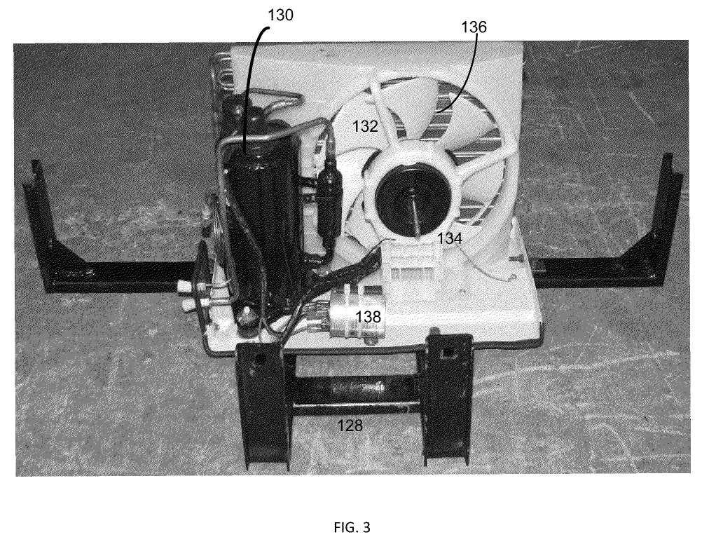

FIG. 3 shows one exemplary AC hardware configuration mounted on a frame 128. The compressor 130 provides compressed Freon or R134a to a condenser 136 which provides surfaces to transfer the heat from the high temperature, high pressure gaseous refrigerant to ambient air causing the refrigerant to condense into liquid. The fan 132 is rotated by the condenser fan. The liquid refrigerant passes through the capillary tube 126 and becomes low pressure liquid. This refrigerant then enters the evaporator 128 which provides cool surfaces for an evaporator blower 140 to blow air and circulate cool air to the cabin.

The air conditioning system keeps the temperature to a comfortable range because of its cooling capability. The system offers the capability of controlling humidity in the cabin while cooling down the air. The system also provides freshening and ventilation. The system can have an efficient purification system that purifies the air as well. Filters can be integrated within the fan assembly or air ducts to purify the air. Dust filters can be used to collect very small particles of dust and microorganisms to avoid the spread of bacteria. The AC, when equipped with filters can assist patients suffering from asthma or allergies.

The control circuit 108 of FIG. 1 can be a wired control using discrete components, or alternatively can be microcontroller based. During use, the electric compressor 130 compresses Freon or R134a for cooling only during the receipt of a voltage. Mounted on a control panel of the vehicle is a temperature control dial for selecting a temperature. Associated therewith is an activation switch mounted on the control panel for transmitting an activation signal upon the depression thereof. Finally, control means, in form of the control circuitry is connected between the fan, compressor, temperature control dial, and activation switch. In use, the control means transmits a predetermined voltage amount to both the fan and the compressor only during the receipt of the activation signal. It should be noted that the predetermined voltage is proportional to the temperature selected by way of the temperature control dial. In a microcontroller implementation, the user selects the temperature control through a digital input such as a keypad or an analog input such as a touch screen that is digitized. The microcontroller interprets the user selection and generates the appropriate voltage to control the fan. Alternatively, if the fan is controlled by pulse widths, the microcontroller causes appropriate PWM signals to control the fan speed. The AC fan in turn generates an amount of cooled air flow that are a function of the duty cycle of the pulses from the pulse width modulator.

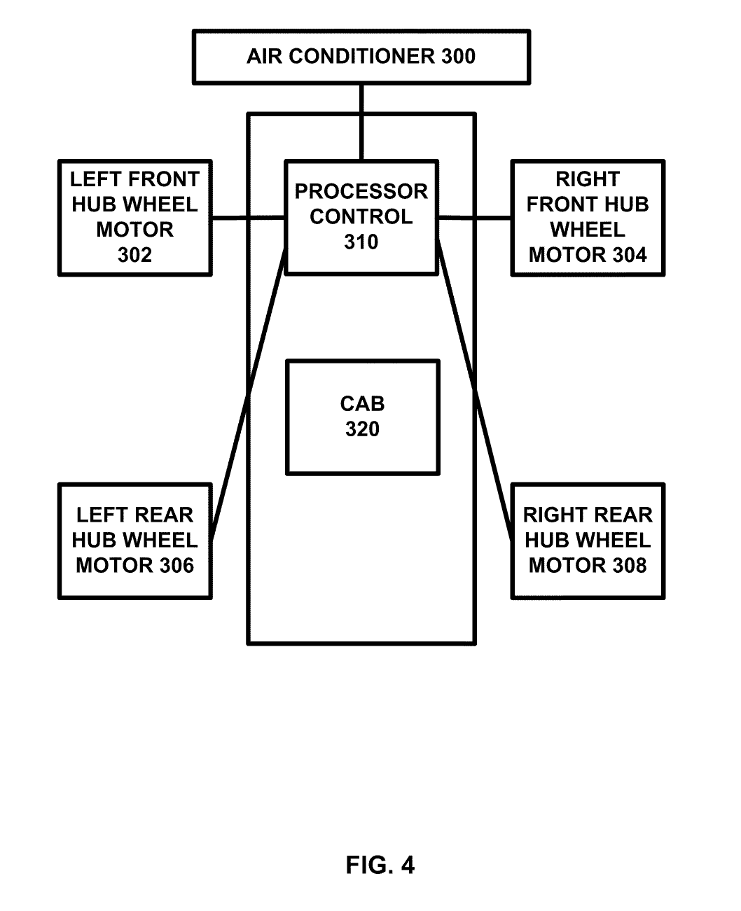

FIG. 4 shows an exemplary air conditioner 300 used in an electric vehicle with hub wheel motors 302-308. The motors 302-308 and the air conditioner 300 are controlled by a vehicle processor 310 to provide transportation to passengers located in a cab 320. The temperature of the cab 320 is controlled to provide environmental comfort to the passengers. The hub motor of FIG. 4 is designed to be small in size. The compact motor assembly is mounted in conjunction with the hub of the car. The motor assembly includes a self contained unit which includes a rotationally driven motor housing that is connected directly to the tire supporting rim of the car wheel. Rotation of the motor housing will result in similar rotation of the tire supporting rim of the wheel. The motor housing has an internal chamber and within that internal chamber is located a stator and a rotor. The stator is fixedly mounted onto a center shaft which passes through the motor housing which is fixedly mounted to the car. The rotor is to be rotated by the electrical energy being supplied to the stator with this rotation being transferred through the drive shaft.

The exemplary hub wheel motor system includes a motor enclosed by a hub cap and a tire supporting rim. A rubber wheel can be mounted on the rim. The back of the hub cap has an opening through which a cable is inserted there through to provide power as well as control signals to the motor. The motor has outer, ring-shaped permanent magnets (stator) that rotate while the inner metallic core (rotor) is fixed. When the motor is switched on, the static rotor stays still while the stator spins around it. A tire is attached to the motor, and as the outer part of the motor rotates, the wheel (or wheels) powers the vehicle forward.

Since the motors are hub-wheel motors, the independently operated air conditioner 300 can cool the cab to provide comfort to the vehicle occupants while they are using the vehicle.

The electric car with hub-wheel motors can be the Alias, available from ZAP, Inc. of Santa Rosa, Calif. The Alias is 100% electric, 100% of the time. Recharging is simple and effortless via any 110V outlet at home or on the road. The Alias has aerodynamic contours, low profile, wide stance with double-wishbone suspension, and sport styling. The vehicle can also be a truck with hub-wheel motors called ZAP Truck XL. Roomy, durable, rugged yet whisper quiet, the ZAPTRUCK XL is the affordable green solution for fleet operations. The electric truck is a utilitarian workhorse providing a roomy cab for two and a convertible bed/platform for moving up to 1600 lbs. of cargo during off-road use. The vehicle is ideal for corporate campuses, warehouses, universities, factories, municipal operations and around the ranch or farm.

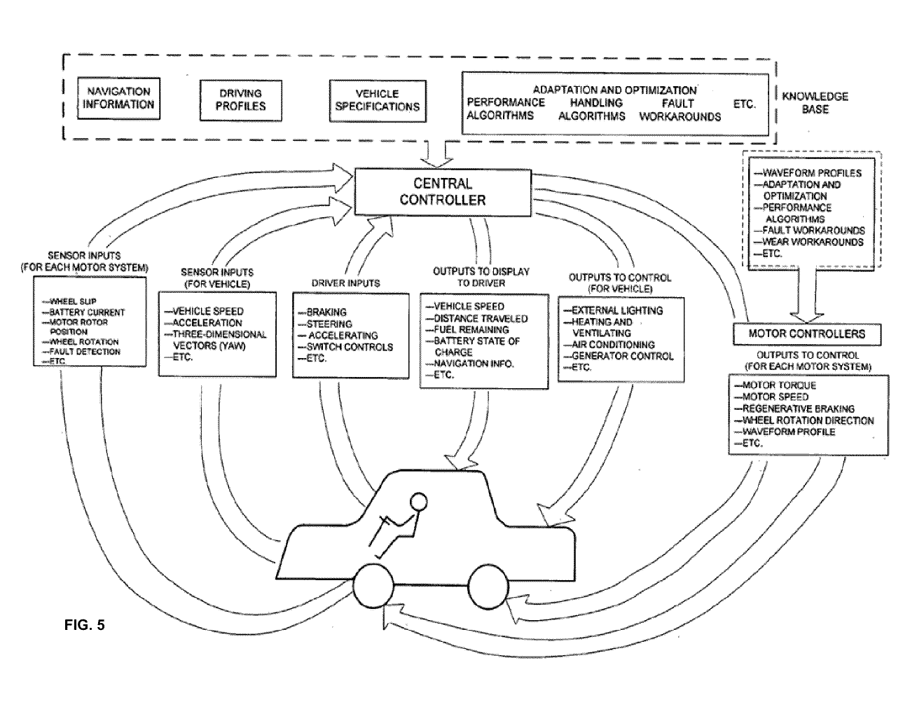

FIG. 5 shows an exemplary environmentally friendly vehicle control system. FIG. 5 shows how a central controller receives various inputs, draws on necessary information (driving profiles, vehicle specifications and navigation information), and produces the appropriate outputs. The central controller makes use of a range of inputs from sensors. The central controller combines this information with driver inputs received through a “user interface.” Typically, these driver inputs include braking, steering, accelerator and the various switch controls. The central controller can then combine these inputs with stored driving profiles, vehicle specifications, and navigation information. Based on all this information, the central controller optimizes for best performance. This requires sending control signals to the motors to continuously control motor torque and speed.

In one embodiment, the central controller senses temperature conditions and issues a command to maintain constant temperature given the weather condition and the occupant's desired temperature range. The central controller linearly ramps down the fan when the temperature is too high and vice versa. The user, through the user interface, can override the processor when conditions change or for any reason. In this manner, the vehicle can increase its efficiency and user comfort while minimizing environmental pollution.

The software controlling the air conditioner 300 can be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The system has been described in terms of specific examples which are illustrative only and are not to be construed as limiting. In addition to control or embedded system software, the system may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

The present invention has been described in terms of specific embodiments, which are illustrative of the invention and not to be construed as limiting. Other embodiments are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

What is claimed is:

1. An electric vehicle, comprising:
a. a frame having a cab;
b. a plurality of hub wheel motors mounted to the frame, each hub wheel motor rotating a wheel; and
c. an air conditioner mounted on the frame and thermally coupled to the cab, wherein the air conditioner includes an inverter driving an electric compressor and the inverter is coupled to an independent battery for air conditioning.

2. The vehicle of claim 1, comprising a driver vent and a passenger vent coupled to the fan.

3. The vehicle of claim 1, wherein the air conditioner comprises a condenser coupled to a capillary tube coupled to an evaporator and an accumulator.

4. The vehicle of claim 1, comprising a battery voltage sensor.

5. The vehicle of claim 1, comprising a cabin temperature sensor.

6. The vehicle of claim 1, comprising a battery temperature sensor.

7. The vehicle of claim 1, comprising a vehicle charger mounted on the frame to charge the independent battery.

8. The vehicle of claim 1, comprising a solar cell coupled to the independent battery and the air conditioner.

9. The vehicle of claim 1, comprising a charger coupled to the independent battery.

10. The vehicle of claim 9, comprising a primary battery coupled to the charger.

11. A method for operating an electric vehicle, comprising:
a. providing a plurality of hub wheel motors to a frame with a cab, each hub wheel motor rotating a wheel;
b. providing an independent battery to power an electric compressor and converting the independent battery's voltage to a compressor voltage with an inverter; and
c. driving an electric compressor with the compressor voltage; and
d. generating and directing cool air at a vehicle interior with a fan or a blower.

12. The method of claim 11, comprising providing cooled air to a driver vent or a passenger vent

13. The method of claim 11, comprising sensing a battery voltage or a battery temperature and turning off the electric compressor and the fan if the battery voltage falls below a battery voltage threshold or if the battery temperature rises above a battery temperature threshold.

14. The method of claim 11, comprising adjusting the air conditioner based on a cabin temperature sensor or a battery temperature sensor.

15. The method of claim 11, comprising powering the air conditioner with a solar cell.

16. An electric vehicle, comprising:
a. a frame having a cab;
b. a plurality of hub wheel motors mounted to the frame, each hub wheel motor rotating a wheel; and
c. an air conditioner mounted on the frame and thermally coupled to the cab, wherein the air conditioner includes an inverter driving an electric compressor and the inverter is coupled to an independent battery for air conditioning, wherein the air conditioner comprises a condenser coupled to a capillary tube coupled to an evaporator and an accumulator.

17. The vehicle of claim 16, comprising a driver vent and a passenger vent coupled to the fan.

18. The vehicle of claim 16, comprising a compressor motor coupled to a capacitor.

19. The vehicle of claim 18, comprising a condenser fan motor coupled to the capacitor.

20. The vehicle of claim 16, comprising an evaporator blower coupled to a relay and a fuse to blow cool air into the cab.
